(19) United States
(12) Patent Application Publication
(10) Pub. No.: US 2014/0290931 A1
(43) Pub. Date: Oct. 2, 2014

(54) High Temperature Solder For Downhole Components

(71) Applicants: University of Maryland, College Park, College Park, MD (US); SCHLUMBERGER TECHNOLOGY CORPORATION, Sugar Land, TX (US)

(72) Inventors: Chandradip Patel, Sugar Land, TX (US); Francis Dupouy, Stonehouse (GB); F. Patrick McCluskey, Ellicott City, MD (US); Mark Kostinovsky, Houston, TX (US); Glen Schilling, Richmond, TX (US)

(73) Assignees: University of Maryland, College Park, College Park, MD (US); SCHLUMBERGER TECHNOLOGY CORPORATION, Sugar Land, TX (US)

(21) Appl. No.: 14/231,009

(22) Filed: Mar. 31, 2014

Related U.S. Application Data
(60) Provisional application No. 61/807,193, filed on Apr. 1, 2013.
(60) Provisional application No. 61/812,537, filed on Apr. 16, 2013.
(60) Provisional application No. 61/836,743, filed on Jun. 19, 2013.

(51) Int. Cl. B23K 35/26; E21B 43/00

(52) U.S. Cl. CPC B23K 35/262; E21B 43/00
USPC 166/66; 420/560

(57) ABSTRACT

A downhole tool conveyable within a wellbore extending into a subterranean formation, wherein the downhole tool comprises a first component, a second component, and a solder electrically and mechanically coupling the first and second components, wherein the solder comprises or consists of: from 0.001 to 1.0 weight % of copper; from 2.5 to 4.0 weight % of silver; from 0.01 to 0.25 weight % of manganese; and tin.

### CROSS-REFERENCE TO RELATED APPLICATION(S)

The present application claims the benefit of related U.S. Provisional Patent Application Ser. No. 61/807,193, filed on Apr. 1, 2013, entitled “High Temperature Solder for Downhole Components,” related U.S. Provisional Patent Application Ser. No. 61/812,537, filed Apr. 16, 2013, entitled “High Temperature Solder for Downhole Components,” and related U.S. Provisional Patent Application Ser. No. 61/836,743, filed Jun. 19, 2013, entitled “High Temperature Solder for Downhole Components,” the disclosures of which are all incorporated by reference herein in their entireties.

### BACKGROUND OF THE DISCLOSURE

Solder is used to electrically and mechanically connect electrical components of downhole tools. For instance, joints may be created by melting the solder between the surfaces to be joined, and then allowing it to solidify, forming the joint. Traditionally tin-lead (HMP) solders have long been used for their high melting point, narrow melting range, fair wetting, reliability, availability and cost advantages. However, the EU Restriction of Hazardous Substances (RoHS) legislation has banned lead from electronics, which has consequently led to development of lead-free alternatives to tin-lead solder. Many attempts at finding alternatives for high temperature applications focused on tin-silver-copper alloys (also known as Sn—Ag—Cu alloys, or SAC alloys), due to their higher melting temperature.

Lower silver content SAC alloys, such as Sn-1.0Ag-0.5Cu (SAC105), have been found to perform well in high shock and vibration environments (e.g., longer joint life), while higher silver content SAC alloys like, such as Sn-4.0Ag-0.5Cu (SAC405), have been found to perform well in high temperature applications (e.g., T>125° C.). While all of these solders have temperatures in the range of 215° C.-225° C., those with lower silver content were found to be more resistant to failure by shock and vibration, but also less resistant to failure by creep, temperature aging, or temperature cycling compared to those with higher silver content. With this in mind, Sn-3.0Ag-0.5 Cu (SAC305) has been found to exhibit a compromise between SAC105 and SAC405, and has found widespread usage in many applications. However, the long-term reliability of SAC305 is questionable under harsh environments, particularly those combining high temperature thermal fatigue with mechanical shock/vibration.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of a downhole tool using the method of the present disclosure.

FIG. 2 is a schematic view of a downhole tool using the method of the present disclosure.

FIG. 3 is a schematic view of an electronic assembly using the method of the present disclosure as a solder layer.

FIG. 4 is a schematic side view of an electronic assembly using the method of the present disclosure as solder balls.

FIG. 5 is a schematic top view of an electronic assembly using the method of the present disclosure as solder balls FIG. 6 is a schematic view of a section of an electronic assembly containing a solder ball according to one or more aspects of the present disclosure.

FIG. 7 is a schematic view of a section of an electronic assembly containing a solder ball according to one or more aspects of the present disclosure.

FIG. 8 is a schematic view of a section of an electronic assembly containing a through hole lead according to one or more aspects of the present disclosure.

FIG. 9 is a schematic side view of a surface mount component assembled to a printed wiring board or other substrate using solder according to one or more aspects of the present disclosure.

FIG. 10 is a schematic top view of a surface mount component assembled to a printed wiring board or other substrate using solder according to one or more aspects of the present disclosure.

FIG. 11 is a black-box diagram of a possible measurement circuit design to be used in an assembly joined with a solder possessing one or more of the aspects of the present disclosure.

FIG. 12 is a graph showing the effect of Mn addition in a SnAgCu alloy for reducing the number of failures during 20 thermal cycles from −40° C. to 185° C.

FIG. 13 is a graph showing the effect of Mn addition in a SnAgCu alloy for reducing the number of failures during 20 thermal cycles from −40° C. to 200° C.

FIG. 14 is a graph showing the effect of Mn addition in a SnAgCu alloy for reducing the number of failures during 20,000 mechanical shocks on components pre-exposed to 20 thermal cycles from −40° C. to 185° C.

FIG. 15 is a graph showing the effect of Mn addition in a SnAgCu alloy for reducing the number of failures during 20,000 mechanical shocks on components pre-exposed to 20 thermal cycles from −40° C. to 200° C.

FIG. 16 is a graph showing the effect of Mn addition in a SnAgCu alloy for improving the characteristic life of QFN44 packages in 20,000 mechanical shocks that pre-exposed to 20 thermal cycles from −40° C. to 185° C.

FIG. 17 is a graph showing the effect of Mn addition in a SnAgCu alloy for improving the characteristic life of QFN44 packages in 20,000 mechanical shocks that pre-exposed to 20 thermal cycles from −40° C. to 200° C.

FIG. 18 is a graph showing the effect of Mn addition in a SnAgCu alloy for improving the characteristic life of QFN32 packages in 20,000 mechanical shocks that pre-exposed to 20 thermal cycles from −40° C. to 185° C.

FIG. 19 is a graph showing the effect of Mn addition in a SnAgCu alloy for improving the characteristic life of QFN32 packages in 20,000 mechanical shocks that pre-exposed to 20 thermal cycles from −40° C. to 200° C.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed except where specifically noted as indicating a relationship.

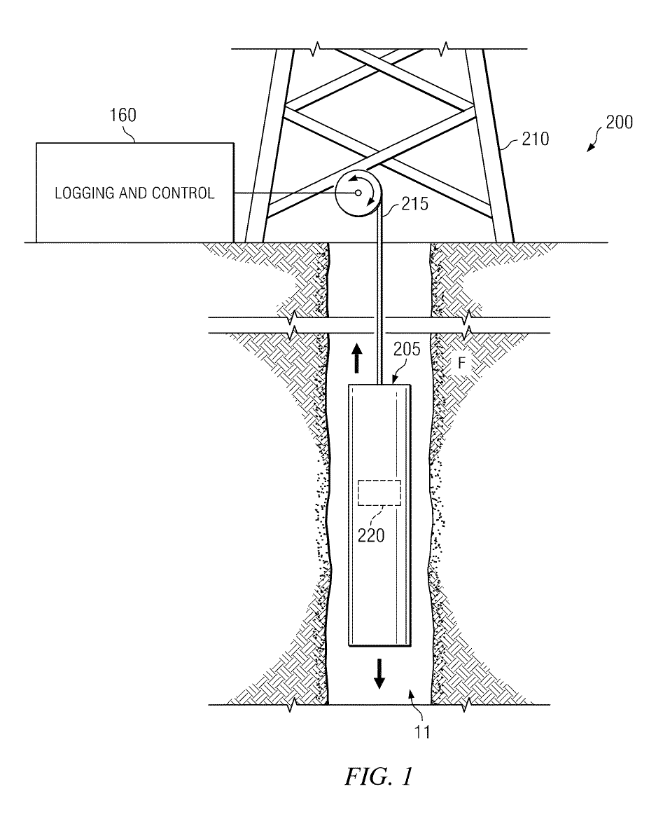

FIG. 1 is a schematic view of an example wellsite system that may be employed onshore and/or offshore according to one or more aspects of the present disclosure. As depicted in FIG. 1, a downhole tool 205 may be suspended from a rig 210 in a wellbore 11 formed in one or more subterranean formations F. The downhole tool 205 may be or comprise an acoustic tool, a conveyance tool, a density tool, a downhole fluid analysis (DFA) tool, an electromagnetic (EM) tool, a fishing tool, a formation evaluation tool, a gravity tool, an intervention tool, a magnetic resonance tool, a monitoring tool, a neutron tool, a nuclear tool, a perforating tool, a photoelectric factor tool, a porosity tool, a reservoir characterization tool, a reservoir fluid sampling tool, a reservoir pressure tool, a reservoir solid sampling tool, a resistivity tool, a sand control tool, a seismic tool, a stimulation tool, a surveying tool, and/or a telemetry tool, although other downhole tools are also within the scope of the present disclosure. The downhole tool 205 may be deployed from the rig 210 into the wellbore 11 via a conveyance means 215, which may be or comprise a wireline cable, a slickline cable, and/or coiled tubing, although other means for conveying the downhole tool 205 within the wellbore 11 are also within the scope of the present disclosure. As the downhole tool 205 operates, outputs of any number and/or type(s) of the downhole tool 205 and/or components thereof (one of which is designated by reference numeral 220) may be sent via, for example, telemetry to a logging and control system 160 at surface, and/or may be stored in any number and/or type(s) of memory(ies) for subsequent recall and/or processing after the downhole tool 205 is retrieved to surface.

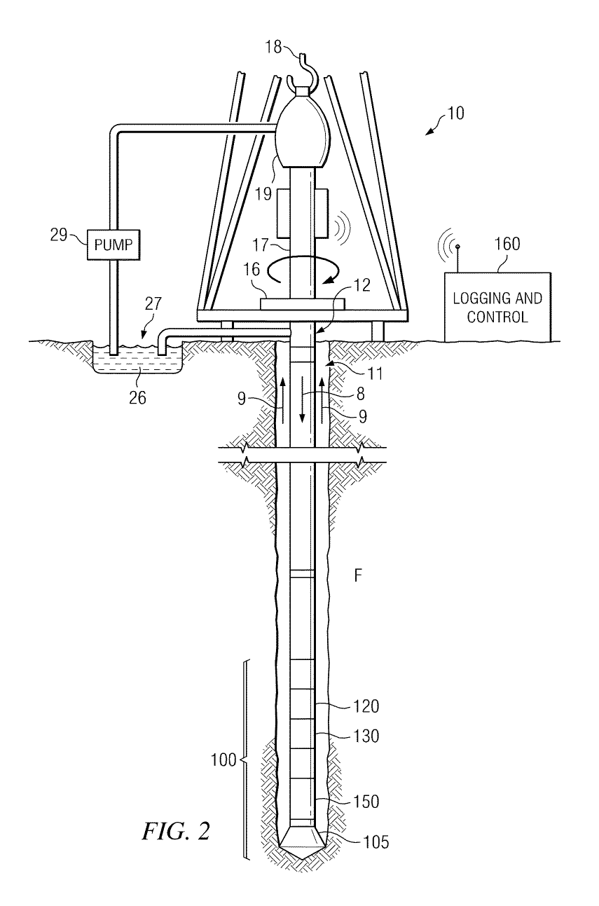

FIG. 2 is a schematic view of an example wellsite system that can be employed onshore and/or offshore, perhaps including at the same wellsite as depicted in FIG. 1, where the wellbore 11 may have been formed in the one or more subsurface formations F by rotary and/or directional drilling. As depicted in FIG. 2, a conveyance means 12 suspended within the wellbore 11 may comprise or be connected to a bottom hole assembly (BHA) 100, which may have a drill bit 105 at its lower end. The conveyance means 12 may comprise drill pipe, wired drill pipe (WDP), tough logging conditions (TLC) pipe, coiled tubing, and/or other means of conveying the BHA 100 within the wellbore 11.

The surface system at the wellsite may comprise a platform and derrick assembly 10 positioned over the wellbore 11, where such derrick may be substantially similar or identical to the rig 210 shown in FIG. 1. The assembly 10 may include a rotary table 16, a kelly 17, a hook 18, and/or a rotary swivel 19. The conveyance means 12 may be rotated by the rotary table 16, energized by means not shown, which may engage the kelly 17 at the upper end of the conveyance means 12. The conveyance means 12 may be suspended from the hook 18, which may be attached to a traveling block (not shown), and through the kelly 17 and the rotary swivel 19, which permits rotation of the drillstring 12 relative to the hook 18. Additionally, or alternatively, a top drive system may be used.

The surface system may also include drilling fluid 26, which is commonly referred to in the industry as mud, stored in a pit 27 formed at the well site. A pump 29 may deliver the drilling fluid 26 to the interior of the conveyance means 12 via a port (not shown) in the swivel 19, causing the drilling fluid to flow downwardly through the conveyance means 12 as indicated by the directional arrow 8. The drilling fluid 26 may exit the conveyance means 12 via ports in the drill bit 105, and then circulate upwardly through the annulus region between the outside of the conveyance means 12 and the wall of the wellbore, as indicated by the directional arrows 9. The drilling fluid 26 may be used to lubricate the drill bit 105, carry formation cuttings up to the surface as it is returned to the pit 27 for recirculation, and/or create a mudcake layer (not shown) on the walls of the wellbore 11. Although not picture, one or more other circulation implementations are also within the scope of the present disclosure, such as a reverse circulation implementation in which the drilling fluid 26 is pumped down the annulus region (i.e., opposite to the directional arrows 9) to return to the surface within the interior of the conveyance means 12 (i.e., opposite to the directional arrow 8).

The BHA 100 may include any number and/or type(s) of downhole tools, schematically depicted in FIG. 2 as tools 120, 130, and 150. Examples of such downhole tools include an acoustic tool, a density tool, a directional drilling tool, a DFA tool, a drilling tool, an EM tool, a fishing tool, a formation evaluation tool, a gravity tool, an intervention tool, a logging while drilling (LWD) tool, a magnetic resonance tool, a measurement while drilling (MWD) tool, a monitoring tool, a mud logging tool, a neutron tool, a nuclear tool, a perforating tool, a photoelectric factor tool, a porosity tool, a reservoir characterization tool, a reservoir fluid sampling tool, a reservoir pressure tool, a reservoir solid sampling tool, a resistivity tool, a seismic tool, a stimulation tool, a surveying tool, a telemetry tool, and/or a tough logging condition (TLC) tool, although other downhole tools are also within the scope of the present disclosure.

The downhole tools 120, 130, and/or 150 may be housed in a special type of drill collar, as it is known in the art, and may include capabilities for measuring, processing, and/or storing information, as well as for communicating with the other downhole tools 120, 130, and/or 150, and/or directly with surface equipment, such as the logging and control system 160. Such communication may utilize any conventional and/or future-developed two-way telemetry system, such as a mud-pulse telemetry system, a wired drill pipe telemetry system, an electromagnetic telemetry system, and/or an acoustic telemetry system, among others within the scope of the present disclosure. One or more of the downhole tools 120, 130, and/or 150 may also comprise an apparatus (not shown) for generating electrical power for use by the BHA 100. Example devices to generate electrical power include, but are not limited to, a battery system and a mud turbine generator powered by the flow of the drilling fluid.

According to one or more aspects of the present disclosure, the downhole tool 215 shown in FIG. 1 and/or one or more of the downhole tools 120, 130, and/or 150 shown in FIG. 2 may comprise a first component, a second component, and a solder electrically and mechanically coupling the first and second components, wherein the solder comprises from 0.001 to 1.0 weight % of copper, from 2.5 to 4.0 weight % of silver, from 0.01 to 0.25 weight % of manganese, and tin. For example, in one implementation within the scope of the present disclosure, the solder comprises 0.48 weight % of copper, 2.99 weight % of silver, 0.17 weight % of manganese, and tin. In another implementation within the scope of the present disclosure, the solder may consist of from 0.001 to 1.0 weight % of copper, from 2.5 to 4.0 weight % of silver, from 0.01 to 0.25 weight % of manganese, and tin, such that the solder comprises no other materials (with the possible exception of unavoidable impurities, contaminants, and the like). For example, the solder may consist of 0.48 weight % of copper, 2.99 weight % of silver, and 0.17 weight % of manganese, with the remainder being tin.

The solder may have a melting point of at least 150° C. For example, the solder may have a melting point of at least 200° C. In one or more implementations within the scope of the present disclosure, the solder may have a melting point of at least 215° C. In one or more implementations within the scope of the present disclosure, the solder may have a melting point from 215° C. to 225° C.

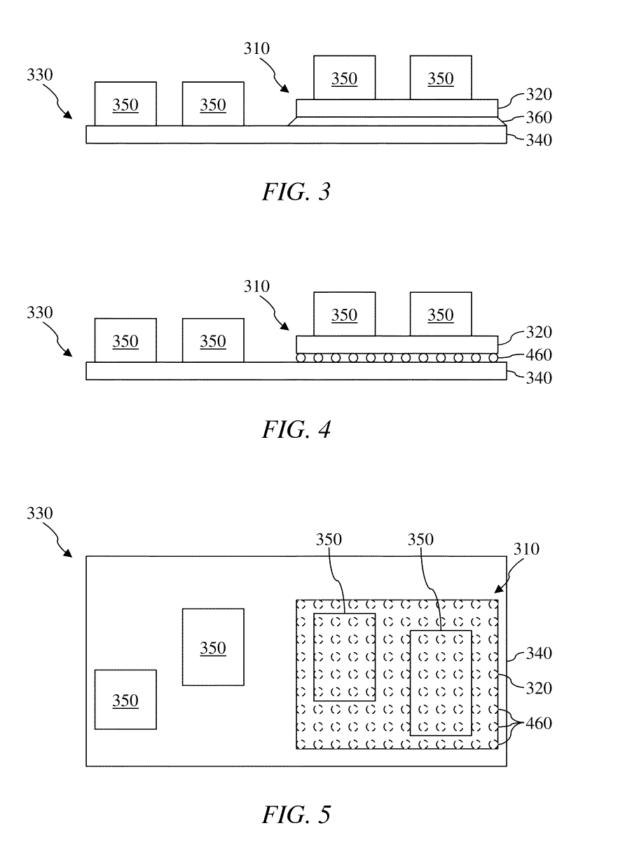

In the example implementation shown in FIG. 3, the first component 310 is (or comprises) a substrate 320, and the second component 330 is (or comprises) a substrate 340. Each of the substrates 320 and 340 may carry one or more electrical components or devices, generally designated by reference numeral 350 in FIG. 3. Solder 360, which may be as described above, may be utilized to mechanically and electronically connect surfaces of the substrates 320 and 340. The solder 360 may be applied as a liquid, solid, or paste. The first component substrate 320 and/or the second component substrate 340 may have surface finishes formed using one or more of electroplated nickel/gold, electroless nickel immersion gold (ENIG), organic solderability preservatives (OSP), immersion silver, and/or immersion tin, although others are also within the scope of the present disclosure. The first component substrate 320 and/or the second component substrate 340 may comprise epoxy, bulk silicon, strained silicon, silicon germanium, and/or other materials, and may also be or comprise a silicon-on-insulator (SOI) substrate, such as a silicon-on-sapphire substrate, a silicon germanium-on-insulator substrate, and/or another substrate comprising an epitaxial semiconductor layer on an insulator layer. The first component substrate 320 and/or the second component substrate 340 may have a <100>, <110>, <111>, or other surface orientation.

In a similar implementation shown in FIG. 4, a plurality of solder balls 460 are utilized instead of (or even in addition to) the solder 360 shown in FIG. 3. For example, the solder balls 460 may be utilized as a 12×9 (or other size) ball grid array (BGA), as more clearly depicted in the example implementation of FIG. 5. Each solder ball 460 in the BGA may comprise about 50 mg of solder, although other amounts are also within the scope of the present disclosure.

Another example implementation within the scope of the present disclosure is shown in FIG. 6, in which the first component 310 comprises a component housing 620 and a connector rod/pin 624, the second component 330 comprises a conductor plate 644 attached to a circuit board or other substrate 640 (which may be substantially similar to one or more of the substrates described above), and a solder ball 660 comprising the solder described above connects the connector rod/pin 624 to the conductor plate 644. The solder ball 660 may be one solder ball of a BGA comprising a plurality of substantially similar solder balls. Prior to connecting the first component 310 to the substrate 640 of the second component 330, the solder ball 660 may be soldered onto the connector rod/pin 624. The first component 310 may then be positioned onto the substrate 640 of the second component 330, and sufficient heating may be applied to the solder ball 660 for it to adhere to the conductor plate 644. However, other processes comprising these and/or other steps, including in an order or sequence other than described above, are also within the scope of the present disclosure.

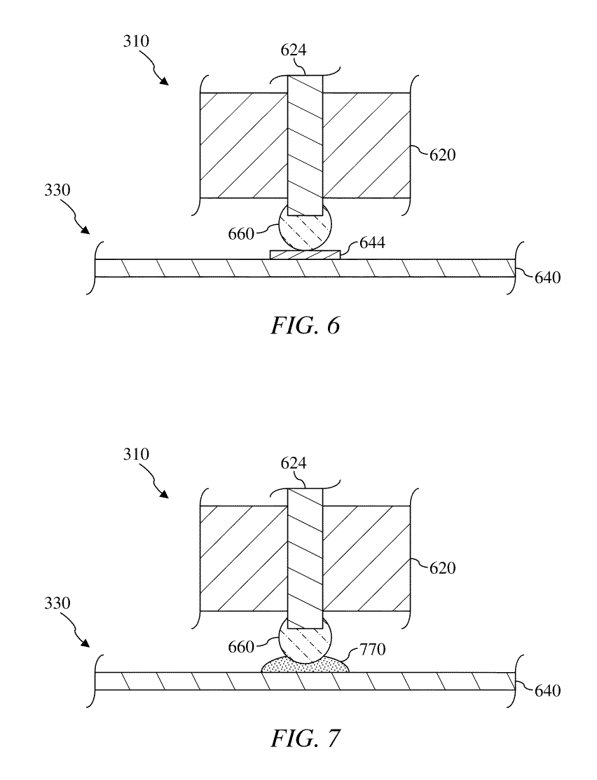

Implementations within the scope of the present disclosure may also comprise utilizing an electrically conductive adhesive to connect the first and second components. In such implementations, the flexible nature of the adhesive may compensate for stresses and shock, such as by thermal expansion, and may prevent cracking or dislodging of the first and second components relative to one another. For example, as shown in FIG. 7, an electrically conducting adhesive 770 may be applied between the solder ball 660 and the substrate 640 of the second component 330. The adhesive 770 may be utilized instead of or in additional to the conductor plate 644 shown in FIG. 6. The adhesive 770 may comprise any conducting adhesive (including the conduction of electricity and/or thermal energy), and may comprise room temperature vulcanization (RTV), as well as metal-based adhesives such as silver conducting RTV, silver conducting adhesive, silver conducting epoxy, gold conducting adhesive, and gold conducting epoxy, among others within the scope of the present disclosure.

In the example implementations depicted in FIGS. 6 and 7, among others within the scope of the present disclosure, the first component 310 may be an electrical component and the second component 330 may be or comprise a substrate, a circuit board, a printed circuit board (PCB), a hybrid board, a multi-chip module, and/or a connector (e.g., a terminal). For example, the first component 310 may be or comprise one or more of an analog-to-digital converter, an antenna, a capacitor, a charge pump, a connector, a controller, a cooling component, a digital logic gate, a digital-to-analog converter, a diode, a heating component, an inductor, an integrated circuit (IC) chip, a memory, a microelectromechanical system (MEMS), a microprocessor, a mixer, an operational amplifier, an oscillator, a programmable logic device (PLD), a receiver, a resistor, a sensor, a state machine, a switch, a temperature control component, a terminal, a transceiver, a transformer, a transistor, a voltage converter, a voltage reference, and/or another electrical device.

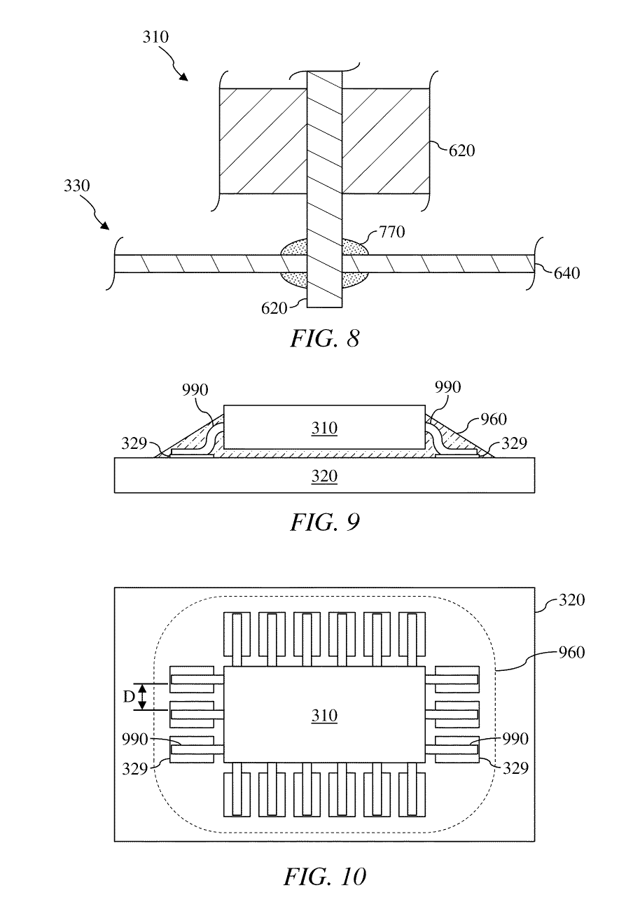

FIG. 8 is a schematic view of another implementation within the scope of the present disclosure that is similar to those shown in FIGS. 6 and 7, in which the first component 310 comprises one or more connector rods/pins 624 extending through the substrate 640 of the second component 330. For example, apertures may be formed through the substrate 640 to accommodate the connector rods/pins 624 passing therethrough. Optionally the electrically conducting adhesive 770 may be applied along the outer surface of the connector rods/pins 624 where they intersect the substrate 640.

FIG. 9 is a schematic view of another implementation within the scope of the present disclosure, in which the first component 310 is a surface mount component, the second component 320 is a substrate, and the first component 310 is mechanically and electrically coupled to the second component 320 by solder 960. The solder 960 may be as described above. The first component 310 may, for example, be an IC chip having a plurality of lead terminals 990 each corresponding to one of a plurality of solder lands 329 at the surface of the second component 320. Each of the lead terminals 990 of the first component 310 may be electrically connected with the corresponding solder land 329 of the second component 320 via the solder 960. The solder 960 and/or an under-fill material (not shown) may also fill the gap between the first component 310 and the second component 320, perhaps surrounding all or a portion of one or more of the lead terminals 990.

The first component 310 may be a fine pitch surface mount technology (SMT) IC chip, as shown in the plan view of FIG. 10. (In FIG. 10, the solder 960 is shown in phantom for the sake of clarity.) The distance “D” between adjacent lead terminals 990 may range between about 0.5 mm and about 1.0 mm, although other value are also within the scope of the present disclosure. The first component 310 may be a Thin Quad Flat Package (TQFP), a Plastic Quad Flat Package (PQFP), a Quad-Flat-No-leads Package (QFN) and the like. The lead terminals 990 may substantially comprise copper or a copper alloy. For example, the lead terminals 990 may comprise CDA725 (Cu—Ni—Sn). The solder lands 329 may each be or comprise a solder pad, such as a tin solder pad and the like. The solder 960 may have a higher melting point than the high temperature environment that may be used for connecting the lead terminals 990 with the solder pads 329. The one aspect, the solder material 110 may have its melting point equal to or higher than about 200 degrees centigrade.

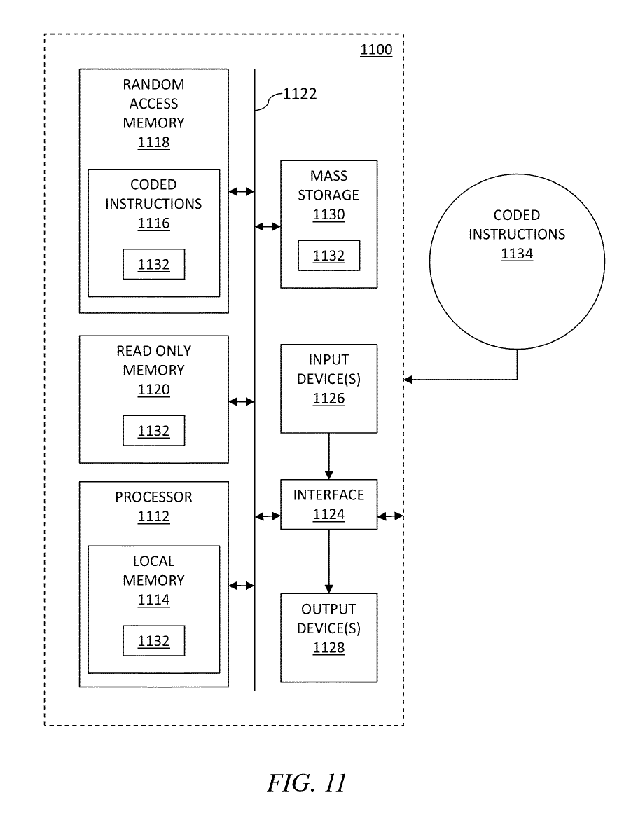

FIG. 11 is a block diagram of an example processing system 1100 that may execute example machine-readable instructions used to implement one or more of the methods and/or processes described herein, and/or to implement the example downhole tools described herein. The processing system 1100 may be or comprise, for example, one or more processors, one or more controllers, one or more special-purpose computing devices, one or more servers, one or more personal computers, one or more personal digital assistant (PDA) devices, one or more smartphones, one or more internet appliances, and/or any other type(s) of computing device(s). One or more of the components of the example processing system 1100 may be assembled utilizing the above described solder, perhaps as shown in one or more of FIGS. 3-10, among other solder coupling methods within the scope of the present disclosure.

The system 1100 comprises a processor 1112 such as, for example, a general-purpose programmable processor. The processor 1112 includes a local memory 1114, and executes coded instructions 1132 present in the local memory 1114 and/or in another memory device. The processor 1112 may execute, among other things, machine-readable instructions to implement the methods and/or processes described herein. The processor 1112 may be, comprise or be implemented by any type of processing unit, such as one or more INTEL microprocessors, one or more microcontrollers from the ARM and/or PICO families of microcontrollers, one or more embedded soft/hard processors in one or more FPGAs, etc. Of course, other processors from other families are also appropriate.

The processor 1112 is in communication with a main memory including a volatile (e.g., random access) memory 1118 and a non-volatile (e.g., read only) memory 1120 via a bus 1122. The volatile memory 1118 may be, comprise or be implemented by static random access memory (SRAM), synchronous dynamic random access memory (SDRAM), dynamic random access memory (DRAM), RAMBUS dynamic random access memory (RDRAM) and/or any other type of random access memory device. The non-volatile memory 1120 may be, comprise or be implemented by flash memory and/or any other desired type of memory device. One or more memory controllers (not shown) may control access to the main memory 1118 and/or 1120.

The processing system 1100 also includes an interface circuit 1124. The interface circuit 1124 may be, comprise or be implemented by any type of interface standard, such as an Ethernet interface, a universal serial bus (USB) and/or a third generation input/output (3GIO) interface, among others.

One or more input devices 1126 are connected to the interface circuit 1124. The input device(s) 1126 permit a user to enter data and commands into the processor 1112. The input device(s) may be, comprise or be implemented by, for example, a keyboard, a mouse, a touchscreen, a track-pad, a trackball, an isopoint and/or a voice recognition system, among others.

One or more output devices 1128 are also connected to the interface circuit 1124. The output devices 1128 may be, comprise or be implemented by, for example, display devices (e.g., a liquid crystal display or cathode ray tube display (CRT), among others), printers and/or speakers, among others. Thus, the interface circuit 1124 may also comprise a graphics driver card.

The interface circuit 1124 also includes a communication device such as a modem or network interface card to facilitate exchange of data with external computers via a network (e.g., Ethernet connection, digital subscriber line (DSL), telephone line, coaxial cable, cellular telephone system, satellite, etc.).

The processing system 1100 also includes one or more mass storage devices 1130 for storing machine-readable instructions and data. Examples of such mass storage devices 1130 include floppy disk drives, hard drive disks, compact disk drives and digital versatile disk (DVD) drives, among others.

The coded instructions 1132 may be stored in the mass storage device 1130, the volatile memory 1118, the non-volatile memory 1120, the local memory 1114 and/or on a removable storage medium, such as a CD or DVD 1134.

As an alternative to implementing the methods and/or apparatus described herein in a system such as the processing system of FIG. 11, the methods and or apparatus described herein may be embedded in a structure such as a processor and/or an ASIC (application specific integrated circuit).

In view of all of the above, and FIGS. 1-11, a person of ordinary skill in the art will readily recognize that the present disclosure introduces an apparatus comprising: a downhole tool conveyable within a wellbore extending into a subterranean formation, wherein the downhole tool comprises: a first component; a second component; and a solder electrically and mechanically coupling the first and second components, wherein the solder comprises: from 0.001 to 1.0 percent, based on total weight of the solder, of copper; from 2.5 to 4.0 percent, based on total weight of the solder, of silver; from 0.01 to 0.25 percent, based on total weight of the solder, of manganese; and tin.

The present disclosure also introduces an apparatus comprising: a downhole tool conveyable within a wellbore extending into a subterranean formation, wherein the downhole tool comprises: a first component; a second component; and a solder electrically and mechanically coupling the first and second components, wherein the solder consists of: from 0.01 to 1.0 percent, based on total weight of the solder, of copper; from 2.5 to 3.5 percent, based on total weight of the solder, of silver; from 0.01 to 0.25 percent, based on total weight of the solder, of manganese; and tin.

The solder may have a melting point of at least 150° C. The solder may have a melting point of at least 200° C. The solder may have a melting point of at least 215° C. The solder may have a melting temperature range from 215° C. to 225° C.

The first component may be or comprise a substrate and the second component may be or comprise an integrated circuit chip.

At least one of the first and second components may be or comprise at least a portion of at least one of: an analog-to-digital converter; an antenna; a capacitor; a charge pump; a connector; a controller; a cooling component; a digital logic gate; a digital-to-analog converter; a diode; a heating component; an inductor; an integrated circuit chip; a memory; a micro-electro-mechanical system (MEMS); a microprocessor; a mixer; an operational amplifier; an oscillator; a programmable logic device (PLD); a receiver; a resistor; a sensor; a state machine; a switch; a temperature control component; a terminal; a transceiver; a transformer; a transistor; a voltage converter; a voltage reference; and/or another electrical device.

The downhole tool may be or comprise at least one of: an acoustic tool; a conveyance tool; a density tool; a directional drilling tool; a downhole fluid analysis (DFA) tool; a drilling tool; an electromagnetic (EM) tool; a fishing tool; a formation evaluation tool; a gravity tool; an intervention tool; a logging while drilling (LWD) tool; a magnetic resonance tool; a measurement while drilling (MWD) tool; a monitoring tool; a mud logging tool; a neutron tool; a nuclear tool; a perforating tool; a photoelectric factor tool; a porosity tool; a reservoir characterization tool; a reservoir fluid sampling tool; a reservoir pressure tool; a reservoir solid sampling tool; a resistivity tool; a sand control tool; a seismic tool; a stimulation tool; a surveying tool; a telemetry tool; and/or a tough logging condition (TLC) tool.

The downhole tool may be conveyable within the wellbore by at least one of: coiled tubing; drill pipe; slickline; wired drill pipe (WDP); and/or wireline.

The downhole tool may be or comprise at least one of: a cased-hole tool; and/or an open-hole tool.

The present disclosure also introduces an apparatus for exploring for hydrocarbons in a subterranean formation, drilling to hydrocarbons in the subterranean formation, or producing hydrocarbons from the subterranean formation, comprising: an assembly comprising: at least a portion of a derrick or platform; and the apparatus described above suspended from the derrick or platform in a wellbore extending into the subterranean formation.

The present disclosure also introduces methods of manufacturing, using, repairing, and/or performing maintenance of such apparatus.

The present disclosure also introduces a solder alloy comprising: from 0.001 to 1.0 percent, based on total weight of the solder, of copper; from 2.5 to 4.0 percent, based on total weight of the solder, of silver; from 0.01 to 0.25 percent, based on total weight of the solder, of manganese; and tin. The solder alloy may consist of: from 0.001 to 1.0 percent, based on total weight of the solder, of copper; from 2.5 to 4.0 percent, based on total weight of the solder, of silver; from 0.01 to 0.25 percent, based on total weight of the solder, of manganese; and tin.

### Experimental Procedure:

The experimental approach used to demonstrate the advantages of the Mn microalloyed SAC305 solder is comprised of a series of high temperature thermal cycling and mechanical shock loading conditions. The thermal cycling profile includes high and low temperatures that are usually experienced by electronics used in down-hole tools. The mechanical shock test includes a shock pulse that is usually experienced by electronics used in down-hole tools. In one experiment, electronic components (viz. Quad Flat No-lead 44 (QFN44) and Quad Flat No-lead 32 (QFN32)) were subjected to 20 thermal cycles (viz. −40° C. to 185° C. and from −40° C. to 200° C.) followed by 20,000 mechanical shocks.

### Test Results Discussion:

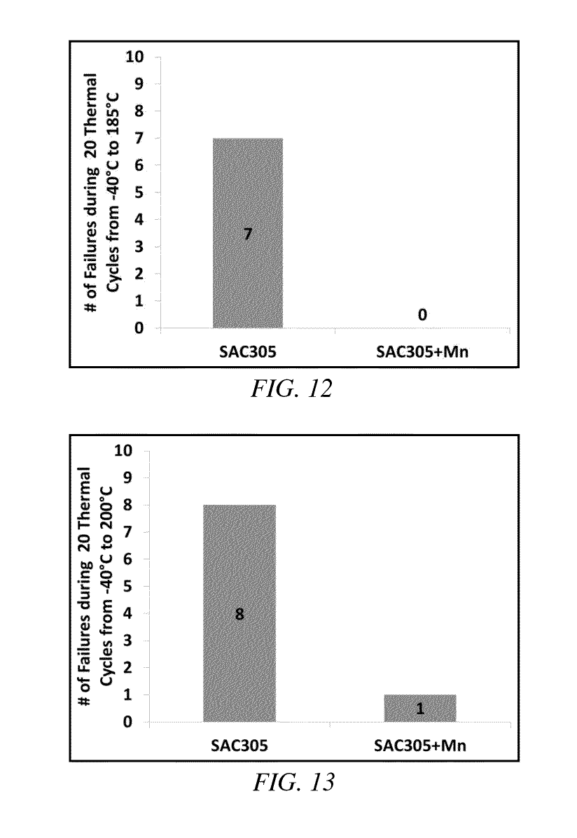

In one of the high temperature thermal cycling tests, a microalloy addition of 0.17% Mn to SAC305 solder was found to reduce the number of failures when compared to SAC305 in QFN44 packages during 20 thermal cycles from −40° C. to 185° C. as shown in FIG. 12.

In another high temperature thermal cycle test, a microalloy addition of 0.17% Mn to SAC305 solder was found to reduce the number of failures when compared to SAC305 in QFN44 packages during 20 thermal cycles from −40° C. to 200° C. as shown in FIG. 13.

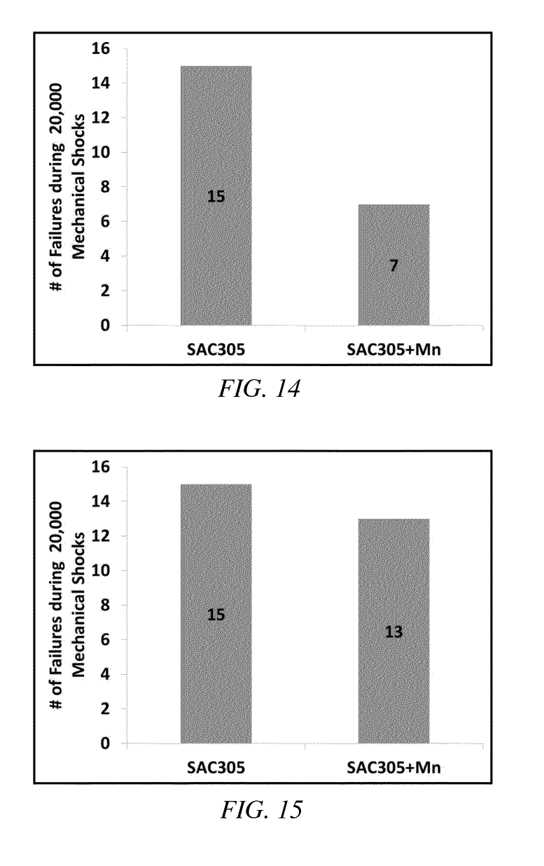

In one of the mechanical shock tests performed on QFN32 packages after pre-exposure to 20 thermal cycles test from −40° C. to 185° C., a microalloy addition of 0.17% Mn with SAC305 solder was found to reduce the number of failures when compared to SAC305 during 20,000 mechanical shocks as shown in FIG. 14.

In another mechanical shock test performed on QFN32 packages after pre-exposure to 20 thermal cycles test from −40° C. to 200° C., a microalloy addition of 0.17% Mn to SAC305 solder was found to reduce the number of failures when compared to SAC305 during 20,000 mechanical shocks as shown in FIG. 15.

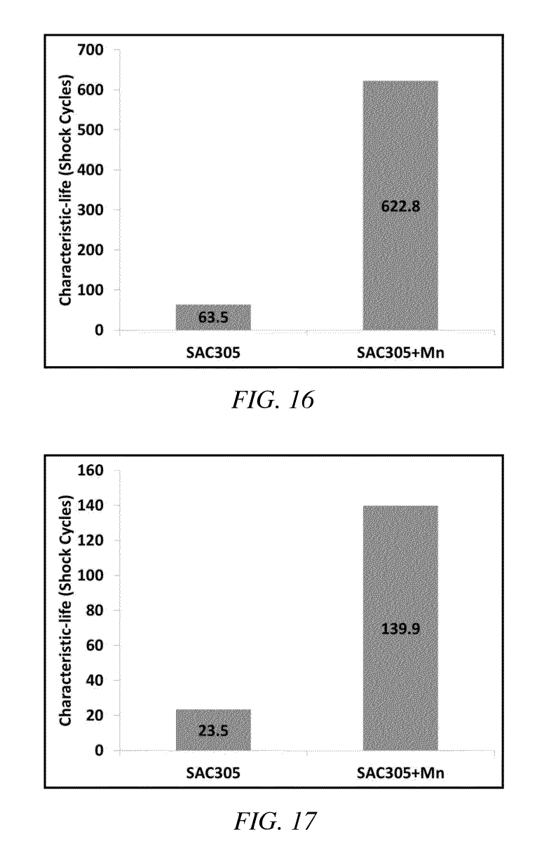

FIG. 16 shows improvement in the characteristic life by microalloy addition of Mn to SAC305 solder during 20,000 mechanical shocks performed on QFN44 packages after pre-exposure to 20 thermal cycles from −40° C. to 185° C.

FIG. 17 shows improvement in the characteristic life by microalloy addition of Mn to SAC305 solder during 20,000 mechanical shocks performed on QFN44 packages after pre-exposure to 20 thermal cycles from −40° C. to 200° C.

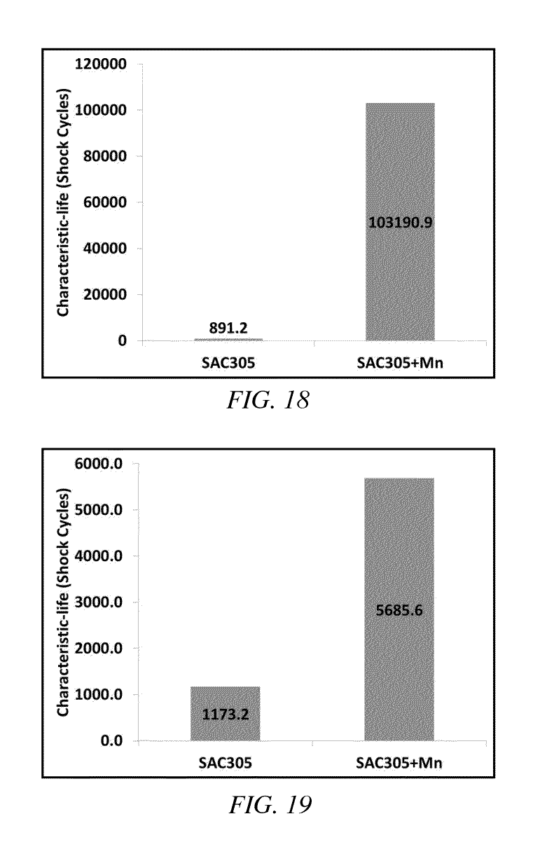

FIG. 18 shows improvement in the characteristic life by microalloy addition of Mn to SAC305 solder during 20,000 mechanical shocks performed on QFN32 packages after pre-exposure to 20 thermal cycles from −40° C. to 185° C.

FIG. 19 shows improvement in the characteristic life by microalloy addition of Mn to SAC305 solder during 20,000 mechanical shocks performed on QFN32 packages after pre-exposure to 20 thermal cycles from −40° C. to 200° C.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same aspects of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

The Abstract at the end of this disclosure is provided to comply with 37 C.F.R. §1.72(b) to allow the reader to quickly ascertain the nature of the technical disclosure. It is submitted with the understanding that it will not be used to interpret or limit the scope or meaning of the claims.

What is claimed is:

1. An apparatus, comprising:
a downhole tool conveyable within a wellbore extending into a subterranean formation, wherein the downhole tool comprises:
a first component;
a second component; and
a solder electrically and mechanically coupling the first and second components, wherein the solder comprises:
from about 0.001 to about 1 percent, based on total weight of the solder, of copper;
from about 2.5 to about 4 percent, based on total weight of the solder, of silver;
from about 0.01 to about 0.25 percent, based on total weight of the solder, of manganese; and
tin.

2. The apparatus of claim 1, wherein the solder has a melting point of at least about 150° C.

3. The apparatus of claim 1, wherein the solder has a melting point of at least about 200° C.

4. The apparatus of claim 1, wherein the solder has a melting point of at least 215° C.

5. The apparatus of claim 1, wherein the solder has a melting temperature range from about 215° C. to about 225° C.

6. The apparatus of claim 1, wherein the first component comprises a substrate and the second component comprises an integrated circuit chip.

7. The apparatus of claim 1, wherein at least one of the first and second components comprises at least a portion of at least one of
an analog-to-digital converter;
an antenna;
a capacitor;
a charge pump;
a connector;
a controller;
a cooling component;
a digital logic gate;
a digital-to-analog converter;
a diode;
a heating component;
an inductor;
an integrated circuit chip;
a memory;
a microelectromechanical system (MEMS);
a microprocessor;
a mixer;
an operational amplifier;
an oscillator;
a programmable logic device (PLD);
a receiver;
a resistor;
a sensor;
a state machine;
a switch;
a temperature control component;
a terminal;
a transceiver;
a transformer;
a transistor;
a voltage converter;
a voltage reference; or
another electrical device.

8. The apparatus of claim 1, wherein the downhole tool comprises at least one of:
an acoustic tool;
a conveyance tool;
a density tool;
a directional drilling tool;
a downhole fluid analysis (DFA) tool;
a drilling tool;
an electromagnetic (EM) tool;
a fishing tool;
a formation evaluation tool;
a gravity tool;
an intervention tool;
a logging while drilling (LWD) tool;
a magnetic resonance tool;
a measurement while drilling (MWD) tool;
a monitoring tool;
a mud logging tool;
a neutron tool;
a nuclear tool;
a perforating tool;
a photoelectric factor tool;
a porosity tool;
a reservoir characterization tool;
a reservoir fluid sampling tool;
a reservoir pressure tool;
a reservoir solid sampling tool;
a resistivity tool;
a sand control tool;
a seismic tool;
a stimulation tool;
a surveying tool;
a telemetry tool; or
a tough logging condition (TLC) tool.

10. The apparatus of claim 1, wherein the downhole tool is conveyable within the wellbore by at least one of coiled tubing, drill pipe, slickline, wired drill pipe (WDP), or wireline.

11. The apparatus of claim 1, wherein the downhole tool comprises at least one of a cased-hole tool or an open-hole tool.

12. A solder alloy, comprising:
from about 0.001 to about 1 percent, based on total weight of the solder, of copper;
from about 2.5 to about 4 percent, based on total weight of the solder, of silver;
from about 0.01 to about 0.25 percent, based on total weight of the solder, of manganese; and
tin.

13. The solder alloy of claim 12, wherein the solder alloy consists essentially of:
from about 0.001 to about 1.0 percent, based on total weight of the solder, of copper;
from 2.5 to 4.0 percent, based on total weight of the solder, of silver;
from 0.01 to 0.25 percent, based on total weight of the solder, of manganese; and
tin.

14. The solder alloy of claim 12, wherein the solder alloy has a melting point of at least about 150 degrees Celsius.

15. The solder alloy of claim 12, wherein the solder alloy has a melting point of at least about 200 degrees Celsius.

16. The solder alloy of claim 12, wherein the solder alloy has a melting point of at least about 225 degrees Celsius.

17. An apparatus, comprising:
a downhole tool conveyable within a wellbore extending into a subterranean formation, wherein the downhole tool comprises:
a first component;
a second component; and
a solder electrically and mechanically coupling the first and second components, wherein the solder comprises:
from about 0.001 to about 1 percent, based on total weight of the solder, of copper;
from about 2.5 to about 4 percent, based on total weight of the solder, of silver;
about 0.17 percent, based on total weight of the solder, of manganese; and
tin.

18. The apparatus of claim 17, wherein the solder comprises about 0.48 weight % of copper.

19. The apparatus of claim 18, wherein the solder comprises about 2.99 weight % of silver.

20. The apparatus of claim 19, wherein tin comprises the remainder of the solder.
